(19) United States
(12) Patent Application Publication
(10) Pub. No.: US 2002/0081352 A1
(43) Pub. Date: Jun. 27, 2002

(54) Enzyme food supplement composition comprising lipase and lactase

(76) Inventors: Rodger R. Rhode JR., Franklin Lakes, NJ (US); Mark L. Anderson, Carmel, NY (US)

Correspondence Address: FITZPATRICK CELLA HARPER & SCINTO, 30 ROCKEFELLER PLAZA, NEW YORK, NY, 10112, US

(21) Appl. No.: 09/747,819

(22) Filed: Dec. 22, 2000

(51) Int. Cl. A01K 1/00

(52) U.S. Cl. 426/2

(57) ABSTRACT

The invention provides enzyme food supplement compositions comprising a lipase enzyme and a lactase enzyme which can be administered to enhance the hydrolysis of lactose and to treat gastrointestinal disorders associated with ingestion of lactose-containing foods.

### FIELD OF THE INVENTION

This invention relates to an enzyme food supplement composition comprising a lipase and a lactase enzyme, which alleviates gastrointestinal distress caused by ingested food containing the disaccharide lactose.

This invention also relates to a method of alleviating gastrointestinal distress in the gastrointestinal system of a human being, which distress is caused by ingested food containing the disaccharide lactose. In one embodiment, the method of this invention comprises the step of ingesting an enzyme food supplement composition comprising a lactase enzyme and a lipase enzyme to convert the dissacharide lactose contained in ingested food to glucose and galactose which are easily digested by the endogenous enzymes in the gastrointestinal system. The lipase enzyme aids in the digestion of fats and lipids in lactose-containing foods.

### BACKGROUND OF THE INVENTION

The enzyme food supplement composition of this invention was developed to meet the needs of the numerous people who needlessly suffer from gastrointestinal discomfort and flatulence because of the difficulty they have in digesting the dissacharide lactose.

Whole milk normally contains about 5 percent lactose. Milk and products derived from milk which contain lactose, for example, butter, cheese, whey, nonfat milk solids, ice cream, and the like, have long been used as important nutrient components of human or animal diets. While whole milk constitutes a particularly large proportion of the normal infant ration, milk and milk containing products also provide a substantial complement to the usual adult diet. Additionally, milk and milk products, particularly whole milk and products made therefrom, can contain a high content of fats or lipids.

Lactose, or milk sugar, is a dissacharide carbohydrate which is hydrolyzed during the digestive process to glucose and galactose. This hydrolysis is catalyzed by the enzyme lactase, or beta-galactosidase. Although this enzyme is normally present in the intestinal juices and mucosa, recent investigations have shown that a significant portion of the human population is lactose intolerant or lactase deficient. Kern et al., J. Am. Med. Ass'n., vol. 195, pp. 927-30 (1966). Consequently, there is a need for a dietary supplement of lactose-hydrolyzing lactase enzyme in these individuals.

The second enzyme in the composition of the invention is lipase which is present to aid in the digestion of fats or lipids contained in the lactose- containing foods. Lipase enzyme catalyzes hydrolysis of glycerides to fatty acids and glycerol. Digestion of the fats and lipids is believed to enhance the ability of the lactose enzyme to digest the lactose present in the foods and speed relief. Ingested lipids can coat ingested food particles and limit their ability to interact with the lactose enzyme. This coating effect is therefore diminished by enzymatic hydrolysis of the fats or lipids contained in ingested foods. The presence of a lipase enzyme can also help counteract maldigestion of such fats or lipids which can cause or aggravate heartburn, hiatus hernia and esophageal reflux.

The enzyme compositions of this invention are of value to any one who has suffered gastrointestinal distress caused by ingesting foods containing lactose.

To the best of applicant's knowledge, the presently claimed enzyme compositions are the first such compositions that seek to alleviate the problem of gastrointestinal distress by utilizing the unique combination of a lipase and a lactase enzymes.

The major advantage of the present invention is that the unique combination of enzymes is able to convert, effectively in the gastrointestinal system of an animal, in particular human beings, an undigestible dissacharide lactose to digestible reducing sugars galactose and glucose, thereby alleviating gastrointestinal distress which is normally associated with the ingestion of foods containing lactose.

Accordingly, it is an object of the present invention to provide an enzyme composition comprising a lipase enzyme and a lactase enzyme. The compositions are primarily useful as a digestive aid for lactose-containing foods and are therefore also referred to herein as enzyme food supplement compositions.

It is still another object of the present invention to provide a method for enhancing the hydrolysis of lactose in an animal in need thereof by administering to the animal an enzyme supplement composition comprising a lipase and a lactase enzyme.

It is a further object to the present invention to provide a method of reducing lactase deficiency in an animal in need thereof by administering to the animal an enzyme supplement composition comprising a lipase and a lactase enzyme.

These and additional objects and advantages of the present invention are shown from the description below. The disclosures of the patents and publications cited throughout this specification are incorporated in their entirety to more fully describe the invention and to demonstrate the state of the art.

### SUMMARY OF THE INVENTION

The present invention provides a food supplement composition comprising a lactase enzyme and a lipase enzyme.

The present invention further provides a method for enhancing the hydrolysis of lactose in an animal in need thereof by administering to the animal a composition comprising a lipase enzyme and a lactase enzyme.

The present invention also provides a method of alleviating gastrointestinal distress, which distress is caused by ingested food containing lactose, said method comprising the step of ingesting a composition comprising a lactase enzyme and a lipase enzyme.

### DETAILED DESCRIPTION OF THE INVENTION

The composition of this invention comprises a lactase enzyme and a lipase enzyme. The composition, which is also referred to herein as an food supplement composition or enzyme food supplement composition, is useful to alleviate gastrointestinal distress in the gastrointestinal system of an animal, which distress is caused by ingested food containing lactose. The lactase in the composition is present to convert the dissacharide lactose contained in the ingested food to reducing sugars glucose to galatose. The lipase enzyme is present to aid in digestion of fats and lipids associated with lactose-containing foods, thereby enhancing the activity of the lactase enzyme.

The present invention therefore provides a method of alleviating gastrointestinal distress in an animal in need thereof, which distress is caused by ingested food containing lactose, said method comprising the step of administering to the animal a composition comprising a lactase enzyme and a lipase enzyme. In the preferred embodiment of the methods of this invention, the animal is a human being.

The present invention also provides a method for enhancing the hydrolysis of lactose in an animal in need thereof by administering to the animal a food supplement composition comprising a lipase enzyme and a lactase enzyme.

The lactase enzyme useful in the invention is defined as an enzyme which is capable of hydrolyzing lactose. Lactose hydrolyzing lactase enzymes are known to be produced by various yeasts, bacteria and fungi. Among the organisms heretofore disclosed as useful for this purpose are yeasts such as Saccharomyces fragilis, Torula cremoris and Torula utilis, bacteria such as Escherichia coli and Lactobacillus bulgaricus, fungi such as Aspergillus oryzae, Aspergillus flavus and Aspergillus niger, and various other micro-organisms and preparations such as those described in U.S. Pat. Nos. 3,629,073; 2,681,858; 2,781,266; and 2,809,113. The lactase enzyme that is preferred is obtained from Aspergillus niger. However, lactase enzyme from more than one source can be incorporated into the composition of the invention.

The lipase enzyme useful in the invention is defined as an enzyme which is capable of hydrolyzing lipids. The lipase enzyme that is preferred is obtained from Aspergillus niger. Although the use of a lipase enzyme from the fungal source Aspergillus niger is preferred, the invention is not, however, to be limited by the source of the lipase enzyme. As described above for lactase enzyme, lipase enzyme from more than one source can be incorporated into the composition of the invention. Although the lipase enzyme can be obtained by culturing the Aspergillus niger organism, then extracting and purifying the enzyme by known and conventional techniques, the applicant has found it more efficient to purchase the lipase enzyme from any one of the following sources: Bio-Cat, Inc., Industrial Drive, Louisa, Va. 23093; Amano International Enzyme Company, Inc., 250 East Zion Crossroads, Troy, Va. 22974.

The lipase enzyme and lactase enzyme may be used, in accordance with the subject invention, in the following concentrations: for the lipase enzyme, a concentration of at least 1 FIP unit per gram of the composition; and for the lactase enzyme, a concentration of at least 1 FCCLU unit per gram of the composition. In a preferred embodiment the lipase enzyme is present in a range of about 1 to about 150,000 units per gram of the composition; and the lactase is present in a range of about 1 to about 100,000 units per gram of the composition. The amount of the enzyme in the formulation is otherwise not critical. However, for reasons of economics, an excessive quantity of enzyme should be avoided, and for reasons of utility, at least the minimum amount to produce satisfactory results should be used.

Another ingredient which is commonly added, although not essential, to the compositions of the present invention is a carrier material. Suitable carrier materials include corn or potato starch, maltodextrins, modified starches, direct compression tablet excipients such as dicalcium phosphate, calcium sulfate and sucrose. A particularly preferred carrier ingredient is the 10 DE Maltrin M100 maltodextrin from Grain Processing Corporation. Carriers can be added in concentrations ranging from 50 to 95 weight percent of the total composition.

The enzyme composition of the invention can be incorporated into dietary supplements, food products or beverages by methods known to those of ordinary skill in the art. Examples of suitable food products include baked goods and non-baked goods such as nutritional bars, muffins, breads, cakes, energy gels, drink mixes and the like. Examples of beverages include flavored and unflavored waters, energy drinks, sports drinks, carbonated and non-carbonated soft drinks, teas and the like. The composition can also be used as an additional ingredient in dietary formulations of processed and non-processed foods.

Those skilled in the art recognize that a dietary supplement containing the composition of the invention and “foods” or “beverages” containing the composition of the invention can be the same form, differing only by the amount of enzyme composition included in each. When the amount of the enzyme composition incorporated in a food or beverage rises to a level of providing recommended daily values they are referred to as dietary supplements. Thus, for example, dietary supplements can also be pills, tablets, capsules, powders, baked and non-baked goods, or carbonated and non-carbonated beverages, and the like depending on the amount of enzyme composition incorporated.

The enzyme composition may also be administered orally in unit dosage form as an aqueous composition administered by oral drops or in any of the usual solid forms such as pills, tablets, capsules, liquid or solid cachets, or powders, including sustained release preparations. Liquid cachets are preferred. Such pills, tablets, capsules, cachets and powders incorporating the enzyme composition of the invention can be prepared by standard methods known to those of ordinary skill in the art.

The term unit dosage form as used in this specification and the claims refer to physically discrete units to be administered in single or multiple doses to animals including humans, each unit containing a predetermined quantity of active material, i.e., lipase and/or lactase enzyme, optionally in association with one or more carriers. The quantity of active material is that amount calculated to produce the desired nutritional or therapeutic effect upon administration of one or more of such units.

Unit doses can be administered in any convenient amount or dosing schedule to achieve the stated beneficial effects. For example, the doses can be taken 1, 2, 3, 4, 5 or more times daily. Preferably, the doses are taken at meal times when ingestion of lactose-containing foods is anticipated and can be taken prior to or during ingestion of lactose-containing foods.

Various other additives which are conventionally added to enzyme food supplement compositions, such as diluents, binders, lubricants, disintegrators, coloring or flavoring agents, preservatives and the like, may be utilized.

Further conventional ingredients and formulations for use in preparing enzyme supplement compositions are disclosed in U.S. Pat. No. 3,629,073, the contents of which are incorporated by reference.

The enzyme supplement compositions of this invention can also be used in connection with other enzyme supplement compositions, or can be combined with other enzymes in a single enzyme composition, to be used for example as a digestive aid. Additional enzymes that may be incorporated include, but are not limited to, beta-fructofuranosidase, cellulase, hemicellulase, and acid protease.

One method of ingredient incorporation for the enzyme food supplement compositions, in accordance with this invention, and as used to formulate the examples is as follows:

### EXAMPLE

In one embodiment, a typical lactase and lipase enzyme composition of the invention comprises the following ingredients: (1) approximately 25 weight percent of lactase (ex Aspergillus niger) containing approximately 10,000 FCCLU units per gram of lactase obtained from Bio-Cat, Inc.; (2) approximately 25 weight percent of lipase (ex Aspergillus niger) containing approximately FIP units per gram of lipase obtained from Bio-Cat, Inc. The remainder of the composition consists of 50 weight percent potato starch and/or maltodextrin.

The FIP units per gram for the lipase enzyme and the FCCLU units per gram for the lactase enzyme are standard units of enzyme activity per gram of individual enzyme. One FIP unit of enzyme activity is the amount contained in a standard preparation which liberates one microequivalent of fatty acid per minute under the conditions of the assay. Pharmaceutical Enzymes, Microbial Lipases §8, pp. 210-213. The specific activity is expressed in international FIP units per mg of enzyme preparation. One F.C.C. Lactase Unit (FCCLU/GM) of enzyme activity is defined as that activity which will liberate 1 micromole of o-nitrophenol per minute under the conditions of an assay which is based on a 15 minute hydrolysis of an o-nitrophenyl-b-D-galactopyranoside (ONPG) substrate at 37° C. and pH 4.5. Food and Chemical Codex Vol.#4, 1996 pp. 802-803.

The compositions of the present invention may be illustrated by way of the above example which is presented for illustration and not intended to be limiting to the scope of the invention. The invention is not to be limited except as set forth in the following claims.

What is claimed is:

1. A food supplement composition comprising a lactase enzyme and a lipase enzyme.

2. The composition of claim 1, wherein the lipase enzyme is obtained from Aspergillus niger.

3. The composition of claim 1, wherein the lipase enzyme is present at a concentration of about 1 FIP unit to about 150,000 FIP units per gram of the composition and the lactase enzyme is present at a concentration of about 1 FCCLU unit to about 100,000 FCLU units per gram of the composition.

4. The composition of claim 1, wherein the lactase enzyme is obtained from Aspergillus niger.

5. The composition of claim 1 in unit dosage form.

6. The composition of claim 5, wherein the unit dosage form is chosen from the group consisting of pill, tablet, capsule, cachet and powder.

7. A food product comprising the food supplement composition of claim 1.

8. A method of alleviating gastrointestinal distress in an animal in need thereof, said method comprising the step of administering to the animal a food supplement composition consisting of a lactase enzyme and a lipase enzyme.

9. The method of claim 8, wherein the lipase enzyme is obtained from Aspergillus niger.

10. The method of claim 8, wherein the lactase enzyme is obtained from Aspergillus niger.

11. The method of claim 8, wherein the lipase enzyme is present in the composition at a concentration of about 1 FIP unit to about 150,000 FIP units per gram of the composition and the lactase enzyme is present in the composition at a concentration of about 1 FCCLU unit to about 100,000 FCLU units per gram of the composition.

12. The method of claim 8 wherein the composition is administered in unit dosage form.

13. The method of claim 12, wherein the unit dosage form is chosen from the group consisting of pill, tablet, capsule, cachet and powder.

14. The method of claim 8 wherein the composition is administered as part of a food product comprising the composition.

15. A method for enhancing the hydrolysis of lactose in an animal in need thereof by administering to the animal a food supplement composition comprising a lipase enzyme and a lactase enzyme.

16. The method of claim 15, wherein the lipase enzyme is obtained from Aspergillus niger.

17. The method of claim 15, wherein the lactase enzyme is obtained from Aspergillus niger.

18. The method of claim 15 wherein the composition is administered in unit dosage form.

19. The method of claim 18, wherein the unit dosage form is chosen from the group consisting of pill, tablet, capsule, cachet and powder.

20. The method of claim 18 wherein the composition is administered as part of a food product comprising the composition.

21. The method of claim 15, wherein the lipase enzyme is present in the composition at a concentration of about 1 FIP unit to about 150,000 FIP units per gram of the composition and the lactase enzyme is present in the composition at a concentration of about 1 FCCLU unit to about 100,000 FCLU units per gram of the composition.
